(19) United States
(12) Patent Application Publication
(10) Pub. No.: US 2009/0064745 A1
(43) Pub. Date: Mar. 12, 2009

(54) Combination mechanism

(76) Inventor: Zachary L. Skelly, Ogdensburg, NY (US)

Correspondence Address: ZACHARY L SKELLY, 605 ELIZABETH STREET, OGDENSBURG, NY, 13669, US

(21) Appl. No.: 11/900,359

(22) Filed: Sep. 11, 2007

(51) Int. Cl. E05B 51/00; E05B 15/00

(52) U.S. Cl. 70/320; 70/286

(57) ABSTRACT

A combination device that, when operated through a dial through one of multiple pre-determined combinations, rotates internal Barriers and aligns a system of holes that allow an optical emitter to extend a beam of light to an optical receptor which sends a signal to a locking mechanism to disengage its lock. Also, by rotating the dial outside of the pre-determined combinations, the Barriers' holes are out of alignment and thusly no signal may be sent, which sends a signal to a locking mechanism to engage its lock.

### CROSS-REFERENCE TO RELATED APPLICATIONS

U.S. Pat. No. 2,008,150, Jul. 16, 1935, Nelson, Arthur S., Patent No.: U.S. Pat. No. 6,434,981, Aug. 20, 2002, Fantl, et al., U.S. Pat. No. 6,764,007, July 2004, Moorhouse et al., U.S. Pat. No. 5,552,587, September 1996, Moorhouse, John H.

### STATEMENT REGARDING FEDERALLY SPONSORED RESEARCH DEVELOPMENT

Not applicable.

### REFERENCE TO SEQUENCE LISTING, A TABLE, OR A COMPUTER LISTING COMPACT DISK APPENDIX

Not applicable.

### BACKGROUND OF INVENTION

This invention pertains to the field of security locking devices. The problem with locking devices was that no matter how big or expensive they were, someone, somewhere, could figure out a way to uncover the combination, code, key print, or whatever means was necessary in order to unlock the device without permission.

Security locking mechanisms are used to house most of our most precious objects. As I will attempt to explain and prove, this device does not allow a user to uncover the combination, and thusly defeats any attempt by which a thief, or other un-authorized person, from trying to uncover the said combination that would unlock the device. As well, my device incorporates countermeasures against the user being unable to access the protected contents in the event of a lost combination.

As attempted in U.S. Pat. No. 6,434,981, efforts have been made to try and increase the security of locking devices and mechanisms. However, though also utilizing a system of ‘holes’ as this patent does, that patent still relies on a mechanical action to unlock the device. This mechanical action can be detected by some means, simply because action can be sensed by sensory devices. My invention, however, does not have a mechanical action associated with the implementation of the combination, and thusly cannot be detected by such means. Instead, my device employs a passive means of detection, whereby the users actions are not the cause of the unlocking, but rather allow the unlocking to occur.

There also have been other advancements along the line of optical technology, such as those utilized in U.S. Pat. Nos. 5,552,587 and 6,764,007. They differ greatly from my invention, though, in many respects. Firstly, those referenced are computerized locks. My device, though electronic, is not computerized and has no ‘central processing unit’ of any kind. Secondly, those referenced also utilize a physical key to complete the combination. My device, in traditional combination lock pattern, uses a turn dial, for both aesthetic and security purposes. With those referenced, you need only posses the key to unlock the device. With mine, you must actually know the combination or it will not unlock. A key can be forged, but a numeric combination cannot. Also, the very mechanics function differently, with those referenced utilizing multiple light sources and fiber optic cables, whereas my device is much more simplified utilizing no method of light transportation beyond the emitters own abilities.

The device created in U.S. Pat. No. 2,008,150 adequately addresses the concerns of the above referenced patents. As mine does, it employs mechanical-optical technology for a passive means of unlocking the device. The only critical flaw of Nelson's patent is that it only allows for one combination at any given time. Not only does Nelson explicitly claim “one predetermined position”, but also he does not claim any such means that would provide for multiple for combinations, as mine does. Given the specific claims that Nelson has made, his device physically could not have such multiple combinations, at least not in the manner that my claim presents.

Be it an absent minded operator, a disaster that destroys the record of the combination, or simply the change of users, there are several inherent flaws with having only one combination at any given time. It is particularly of importance considering that both Nelson's and my devices are, theoretically, unbreakable with respect to their combination code(s). If for whatever reason the single code of Nelson's patent were lost, you would simply have to destroy the device in order to regain the protected contents.

The key difference between Nelson's patent and my own, which allows for multiple combinations, is that my device employs catch bars which provide resistance in only one direction, and multiple series of such catch bars with differing resistance patterns. For example, this means that one would have catch bar “A”, which only resists from the left, and catch bar “B”, which only resists from the right, on the same barrier. Because of the differing resistance patterns of the two catch bars, if the device is manipulated from the left, catch bar “A” would be activated and catch bar “B” would remain passive (meaning that “A”'s position would influence the placement of the barrier's hole). Likewise, if the device is manipulated from the right, catch bar “A” would remain passive and catch bar “B” would be activated (meaning that “B”'s position would influence the placement of the barrier's hole). Though the hole will be in the same position regardless of which catch bar you manipulate, it is by being able to utilize multiple combinations that allows both multiple users with independent combinations, as well as a fail-safe “backup” combination in the event that the end-user loses their combination for whatever reason (and allows the end-user to change their personal combination at will without affecting this fail-safe “backup” combination). It is my belief that Nelson's device was never practical nor largely produced because of that inherent flaw; my device on the other hand already takes into consideration the need for multiple combinations and accordingly, should be successful.

### BRIEF SUMMARY OF THE INVENTION

My invention utilizes a system of holes, aligned by a user operating an input dial, which allows a beam of light to pass through those holes and only through those holes, and is then received by some optical sensor on the other side of holes. When one of the device's multiple combinations is entered properly, the holes are aligned, the light is allowed to pass through and is sensed, and the optical sensor transmits a signal to the lock to disengage. When the beam of light is broken, the sensor sends a signal to engage the lock.

### BRIEF DESCRIPTION OF THE SEVERAL VIEWS OF THE DRAWING

FIG. 1 is a side view of the different Barriers, their components, the Separators, as well as a view of the assembled Barriers and Separators.

FIG. 2 is a front view of the Barriers.

FIG. 3 is a rear view of the Barriers and their components.

FIG. 4 is a front and rear view of the Separators.

FIG. 5 is a slanted view of a Barrier and its pre-drilled hole.

FIG. 6 is a rear view of the Case.

FIG. 7 is a side view the Case.

FIG. 8 is a front view of the Case.

FIG. 9 is an interior view of the assembled device with relation to the Barriers, optical emitter and optical receptor.

FIG. 10 is a slanted side view of an alternative embodiment of the device.

### DETAILED DESCRIPTION OF THE INVENTION:

My invention appears very similar to conventional combination devices in use on safes today. It is operated in the same manner as well. FIG. 9 shows a diagram of the inside of the device. In the PREFERRED EMBODIMENT there will be a series of barriers inside the case and between the optical emitter and sensor. Each barrier should have a hole of uniform size to allow the optical emitter and sensor.

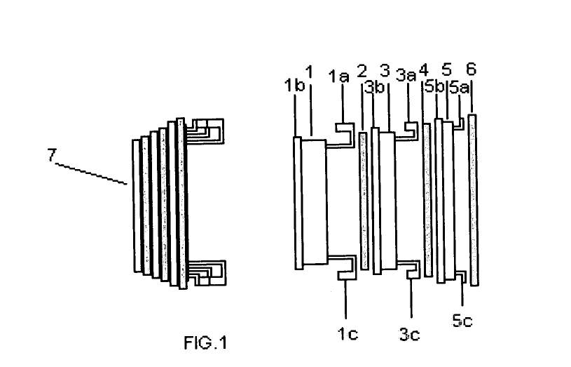

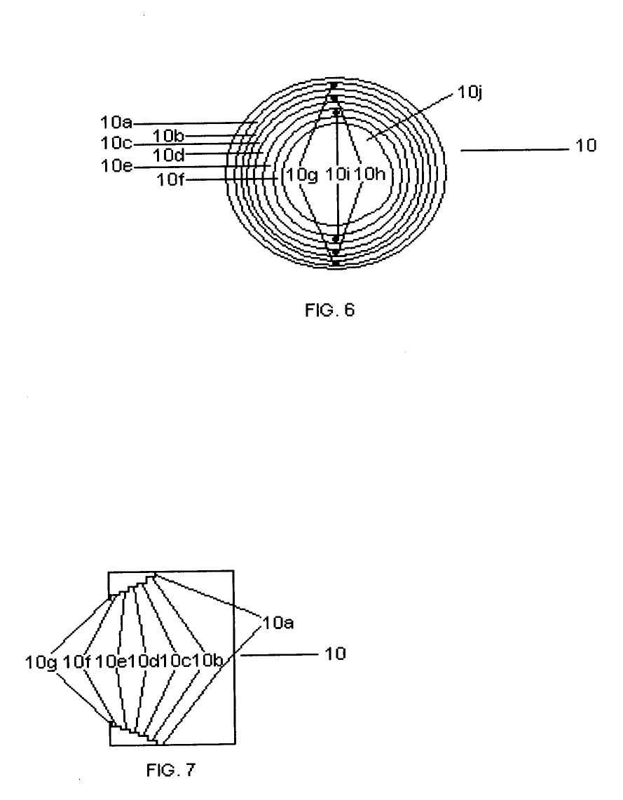

FIG. 1 shows a side view of the Third Barrier. The Third Barrier must be of a size such that its Lip (1b) and deep, hollowed out ring (1) are small enough to fit completely inside the Second Barrier (3), as well as its Lip (1b) having the perimeter of its outer circumference fitting inside the place setting (FIG. 6; 10f) made for it on the interior of the Case (FIG. 6; 10). It must be deep enough so that it will protrude out from the Second Barrier (3) enough space to fit the Third Separator (2) between the Lips of the Third and Second Barriers (7). This Barrier consists of a deep, hollowed out ring (1), a Lip (1b), a Catch Bar which provides resistance to the left (1a) and a Catch Bar which provides resistance to the right (1c). The deep, hollowed out ring (1) allows the light emitter to be placed inside its hollowed out center. The front the Third Barrier (1) is smooth, but from the rear you can see the gap created between the extended Lip (1b ) and the deep, hollowed out ring (1), as well as the rear view of the Catch Bars (1a and 1c). The Lip (1b ) is present so that it fits in between the place setting provided in the Case and the Third Separator (2).

FIG. 1 also shows the Second Barrier. The Second Barrier must be of a size such that its Lip (3b) and deep, hollowed out ring (3) are small enough to fit completely inside the First Barrier (5), as well as its Lip (3b) having the perimeter of its outer circumference fitting inside the place setting (FIG. 6; 10d) made for it on the interior of the Case (FIG. 6; 10). It must be deep enough so that it will protrude out from the First Barrier (5) enough space to fit the Second Separator (4) between the Lips of the Second and First Barriers (7). This Barrier consists of a deep, hollowed out ring (3), a Lip (3b), a Catch Bar which provides resistance to the left (3a) and a Catch Bar which provides resistance to the right (3c). The deep, hollowed out ring (3) allows the First Barrier (5) to be placed inside it. From the front the Second Barrier (3) is smooth, but from the rear you can see the gap created between the extended Lip (3b) and the deep, hollowed out ring (3), as well as the rear view of the Catch Bars (3a and 3c). The Lip (3b) is present so that it fits in between the place setting provided in the Case (FIG. 6; 10) and the Second Separator (4).

FIG. 1 also shows the First Barrier. The First Barrier must be of a size such that its Lip (5b) and deep, hollowed but ring (5c) are small enough to fit completely inside the Case (FIG. 6; 10), as well as its Lip (5b) having the perimeter of its outer circumference fitting inside the place setting (FIG. 6; 10b) made for it on the interior of the Case (FIG. 6; 10). It must be deep enough so that it will not protrude out from the Second Barrier (3) and conform to the size conditions set forth for the Second Barrier (3). This Barrier consists of a deep, hollowed out ring (5), a Lip (5b), a Catch Bar which provides resistance to the left (5a) and a Catch Bar which provides resistance to the right (5c). The deep, hollowed out ring (5) allows the Second Barrier to be placed inside it. From the front the First Barrier (5) is smooth, but from the rear you can see the gap created between the extended Lip (5b) and the deep, hollowed out ring (5), as well as the rear view of the Catch Bars (5a and 5c). The Lip (5b) is present so that it fits in between the place setting provided in the Case and the First Separator (6).

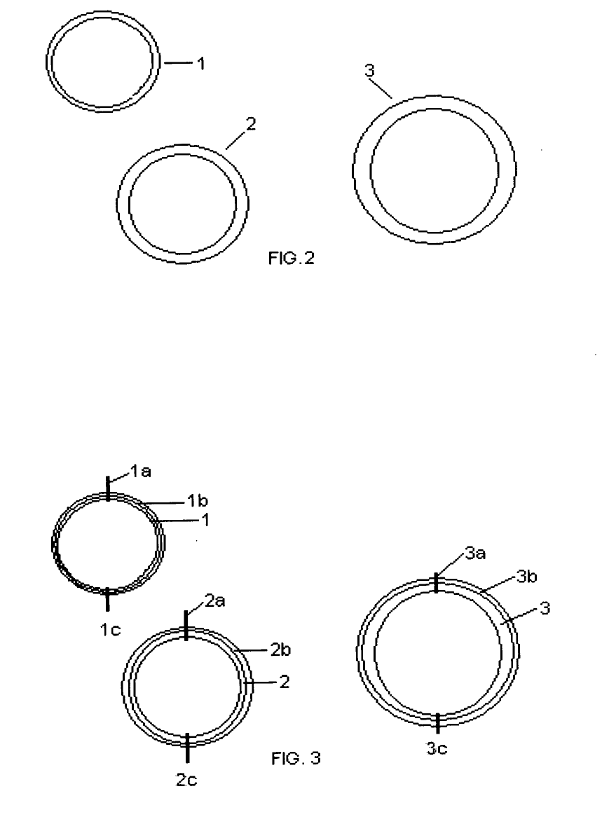

FIG. 2 shows a front view of the Barriers (1, 2, 3).

FIG. 3 shows a rear view of the Barriers° Catch Bars (1a, 1c, 2a, 2c, 3a, 3c), the Lips (1b, 2b, 3b) and the deep, hollowed out rings (1, 2, 3).

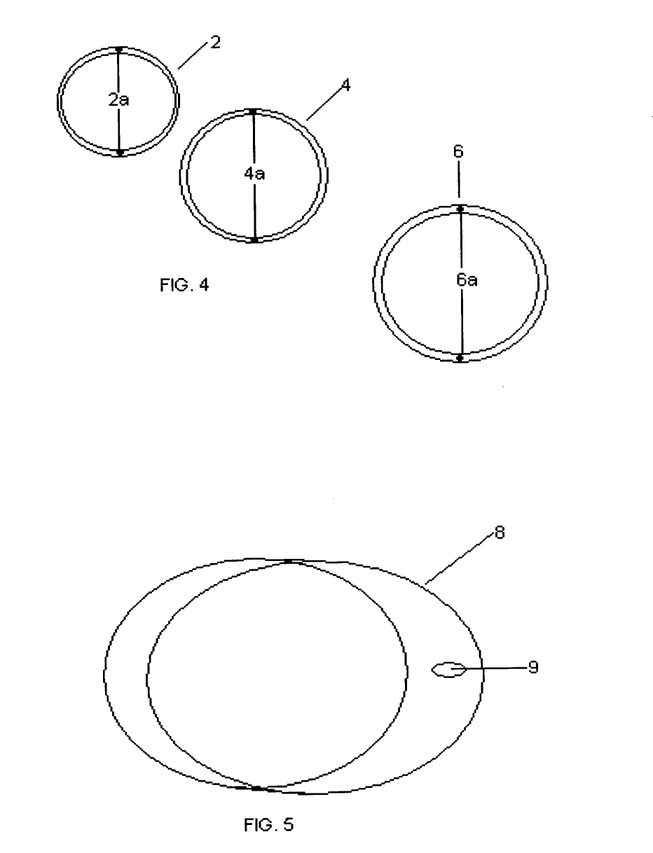

FIG. 4 shows a top view of the Separators (2, 4, 6) and the screw holes (2a, 4a, 6a).

FIG. 5 shows a slanted side view of a Barrier (8) and its hole (9).

FIG. 6 shows a rear view of the Case (10). The inlaid, hollowed rings (10a, 10c, 10e) are of a precise size to allow the placement of the First, Second and Third Barriers. The inlaid, hollowed rings (10b, 10d, 10f) are of a precise size to allow the placement of the First, Second and Third Separators. 10g, 10h and 10i are the screw holes which should be the same size and in line with the screw holes on each of the Separators. 10j is the hollowed out space on the back of the front of the case.

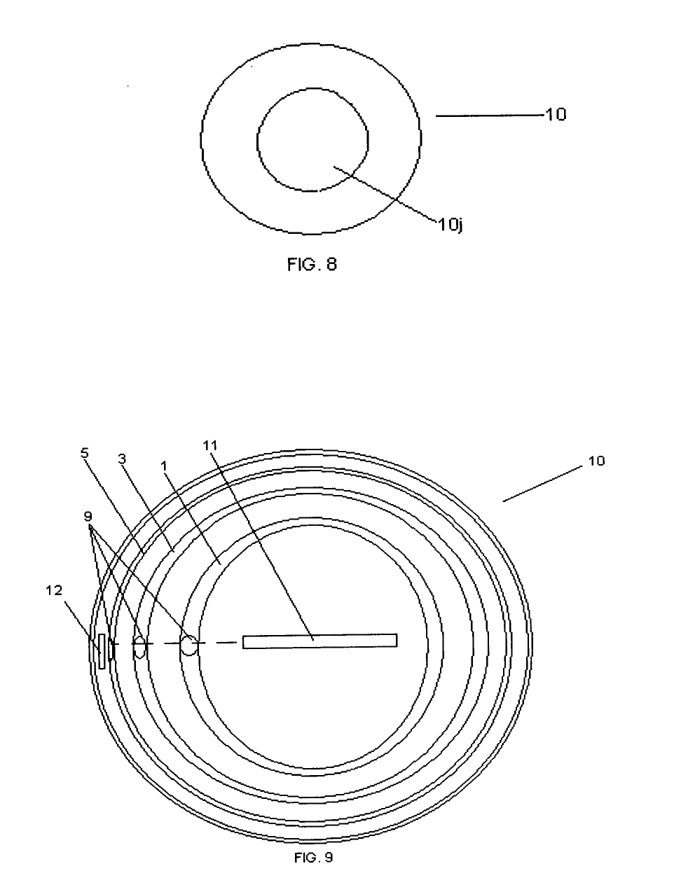

FIG. 7 is a side view of the Case (10).

FIG. 8 shows the front of the Case (10).

FIG. 9 shows a rear view of the assembled device with the Light Emitter (11), Barriers (1, 3, 5), Holes (9) of the Barriers aligned, and the Optical Sensor (12) pictured.

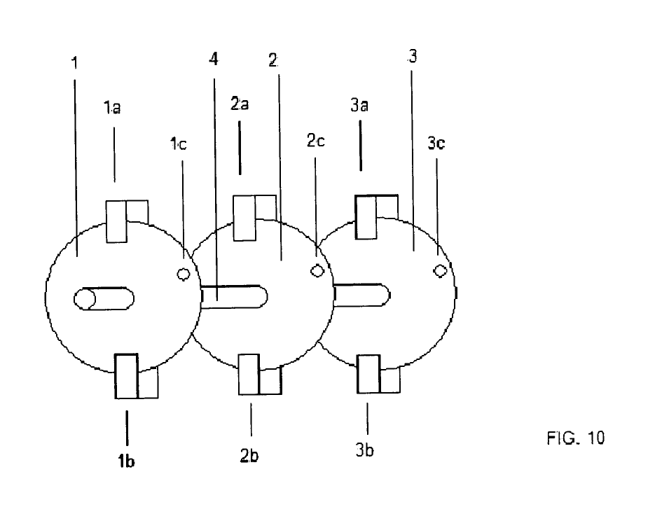

FIG. 10 shows an ALTERNATIVE EMBODIMENT of the device. It depicts three sequential, non-overlapping Barriers (1, 2, 3), two sets of Catch Bars (1a, 2a, 3a and 1b, 2b, 3b), three Holes (1c, 2c, 3c) and a means of connecting the Barriers (4).

The materials used to make the components of the device may be of any solid, sturdy material. The only other consideration to be made would be lining the entire interior of the case, as well as the rear of whichever means that will be attached to the case to operate the Barriers with an appropriate material to prevent any means of seeing inside the device, as well as lining the entire interior of the case, as well as the rear of whichever means that will be attached to the case to operate the Barriers be lined with some heat-sensory blocking material so that the light may not be sensed to prevent any means of deriving the combination by such a method.

To assemble the device, you start with the Case (10). You take the Third Barrier (1) and attach some means to operate the Barriers to the front (Lip side) that is centered, covering the opening of the deep, hollowed out ring, but still small enough to fit inside the Case opening (10j). You then take the Third Barrier (1) with the attached dial, and place it in its fitting placement position (10f), so that the dial is protruding from the front of the Case (10j). You then take the Third Separator (2) and place it over the Third Barrier (1), in its fitting placement position (1e), with the screw holes of the Separator (2a) and placement position (10i) in alignment, and screw it into place. This holds the Third Barrier (1) in position, but still allows it to be moved freely by the dial. You then take the Second Barrier (3) and place it in its fitting placement position (10d). You then take the Second Separator (4) and place it over the Second Barrier (3), in its fitting placement position (10c), with the screw holes of the Separator (4a) and the placement position (10h) in alignment, and screw it into place. This holds the Second Barrier (3) in position. You then take the. First Barrier (5) and place it in its fitting placement position (10b). You then take the First Separator (6) and place it over the First Barrier (5), in its fitting placement position (10a), with the screw holes of the Separator (6a) and the placement position (10g) in alignment, and screw it into place. This holds the First Barrier (5) in position. You then take two sets of Catch Bars with differing resistance patterns and place one Catch Bar from each pattern on each Barrier to form two pre-determined, simultaneous combinations for the device. Now you mount an optical receptor (11) between the deep, hollowed out ring of the First Barrier (5) and the interior edge of the Case (10k). You then mount an optical emitter (12) inside the Third Barrier (1) and attach it to the First Separator (16), so that it will be aligned with the Barrier Holes (9) and the optical receptor (11). You then wire both the optical emitter (11) and receptor (12) outside of the device so that they may be attached to any manufacturer's desired control and energy system, that will both handle powering the system, turning it on and off, as well as sending a signal to the lock device to engage and disengage. Finally, you mount the device onto either a manufacturer's back plate, or directly to the safe or other desired object, in such a manner that would prevent unwanted access to the device's interior.

To use the device you first turn the dial 3 full rotations to the right or the left. Depending on which direction you turn to will designate which pre-determined combination you will be using. This allows the Third Barrier Catch Bar (1a) to catch both the Second Barrier Catch Bar (3a) and the First Barrier Catch Bar (5a) of the same series. To enter the first number of the first combination code, you rotate the dial to the right until you reach the dial number corresponding to the first number in the combination. This will align the First Barrier's (5) hole with the position of the combination code number (in alignment with the optical emitter (11) and receptor (12)). You then turn the dial one full rotation from present position to the left. This will realign the Third Barrier's Catch Bar (1a) so that it is now on the left side the Second Barrier's Catch Bar (3a). To enter the second number of the combination code, you rotate the dial to the left until you reach the dial number corresponding to the second number in the combination. This will align the Second Barrier's (3) hole with the position of the combination code number (in alignment with the optical emitter (11), optical receptor (12), and the First Barrier's (5) hole). To enter the third number of the combination code, you rotate the dial to the right until you reach the dial number corresponding to the third number in the combination. This will align the Third Barrier's (1) hole with the position of the combination code number (in alignment with the optical emitter (11), optical receptor (12), the First Barrier's (5) hole, and the Second Barrier's (3) hole). Now, you have an image like that of FIG. 9, and this allows the manufacturer's control and energy system send a signal from the optical emitter (11) to the optical receptor (12), which in turn sends a signal to the manufacturer's lock device to disengage, allowing entry to the object that this invention is attached to. To enter the second combination code, you would simply follow the above directions, but in the opposite directions indicated. Upon completion, you rotate the Dial any desired direction, any desired number of times, so that the holes (9) are no longer in alignment with the optical emitter (11) and optical receptor (12), which breaks the link between the two, and sends a signal to the manufacturer's control and power system to engage the lock device, so that the object that this invention is attached to is now in a locked state.

What is claimed is:

1. A combination device, comprising
a case to enclose the device,
a single source of light inside the case,
an optical receptor inside the case in line with, but separate from, the single source of light,
a locking means operated by the optical receptor,
a series of barriers positioned between the optical receptor and single source of light,
an open space on each barrier,
catch bars which, when in contact with each other, provide resistance in only one direction, and allow objects to pass by unaffected in all other directions,
a series of such catch bars, which all provide resistance in a manner that allows them to interact with each other appropriately, with one catch bar of the series placed on each barrier,
multiple such series of catch bars placed on the barriers, each with differing resistance patterns so that only the appropriate catch bars in a series will interact with each other and allow all other catch bars from other series to pass by unaffected,
a means of manipulating the barriers, in series, to align their open spaces,
a combination which is derived from the position of each catch bar of a series on each barrier in relation to each barrier's open space,
multiple simultaneous, unique combinations derived from the multiple series of catch bars on the barriers.

2. The invention according to claim 1, with:
catch bars which, after a predetermined number of rotations, will automatically disengage and provide no resistance whatsoever until the device is reset,
multiple series of such catch bars with differing disengaging patterns,
multiple simultaneous pre-determined combinations based on multiple series of such catch bars with differing disengaging patterns.
